(19) United States
(12) Patent Application Publication
(10) Pub. No.: US 2024/0086540 A1
(43) Pub. Date: Mar. 14, 2024

(54) COMPUTER SYSTEM FOR MALWARE DETECTION AND RECOVERY

(71) Applicant: Lear Corporation, Southfield, MI (US)

(72) Inventors: Isaac Snellgrove, Westland, MI (US); Andre Weimerskirch, Ann Arbor, MI (US); Rekha Singoria, Ypsilanti, MI (US); Lars Wolleschensky, Ann Arbor, MI (US); Ran Tao, Ann Arbor, MI (US)

(21) Appl. No.: 17/942,573

(22) Filed: Sep. 12, 2022

(51) Int. Cl. G06F 21/56; G06F 9/455

(52) U.S. Cl. CPC G06F 21/568; G06F 9/45558; G06F 21/565; G06F 2009/45562; G06F 2009/45587; G06F 2221/034

(57) ABSTRACT

Examples of a computer system for malware detection and recovery include a computer having a processor and a memory having untrusted partition having untrusted data files and a trusted partition connected to the untrusted partition and having a backup application. The trusted partition may not be modifiable by the untrusted partition. The computer may be configured to detect whether a malware attack of the untrusted partition has occurred. In accordance with detecting that the malware attack has not occurred, the computer creates a trusted backup by storing at least some untrusted data files to a backup memory that is not modifiable by the untrusted partition. In accordance with detecting that the malware attack has occurred, the computer may prevent the creation of an additional trusted backup and may restore compromised files from the trusted backup.

### TECHNICAL FIELD

The present disclosure generally relates to computer systems for malware detection and recovery, which may be utilized in connection with vehicles.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 is a schematic view generally illustrating an embodiment of a system for malware detection and recovery according to teachings of the present disclosure.

FIG. 2 is a schematic view generally illustrating an embodiment of an untrusted partition according to teachings of the present disclosure.

FIG. 3 is a schematic view generally illustrating an embodiment of a canary file according to teachings of the present disclosure.

FIG. 4 is a schematic view generally illustrating an embodiment of an untrusted partition according to teachings of the present disclosure.

FIG. 5 is a schematic view generally illustrating an embodiment of a critical data file according to teachings of the present disclosure.

FIG. 6 is a schematic view generally illustrating an embodiment of a system for malware detection and recovery according to teachings of the present disclosure.

FIG. 7 is a flow diagram generally illustrating an embodiment of a method of operating a system for malware detection and recovery.

FIG. 8 is a flow diagram generally illustrating an embodiment of a method of operating a system for malware detection and recovery.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments

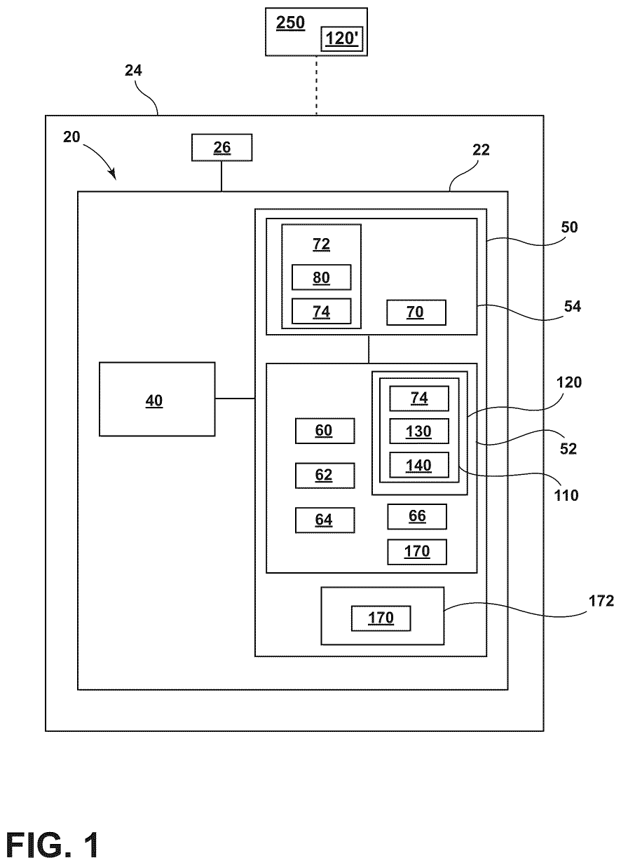

FIG. 1 presents a system 20 including a computer 22 and detects a malware attack and/or for recovering after the malware attack has been detected. A malware attack may include a computer virus, a computer worm, a computer trojan horse, ransomware, and/or spyware, among others. The computer 22 includes a processor 40 and a memory 50 having a trusted partition 52 and/or an untrusted partition 54. The computer 22 is configured to detect a malware attack of the untrusted partition 54. In some configurations, the memory 50 is configured such that the trusted partition 52 is connected to the untrusted partition 54 but the trusted partition 52 is not modifiable by the untrusted partition 54. The trusted partition 52 includes data or code of which integrity can be assured (e.g., verified), for example and without limitation, via cryptographic methods (e.g., secure boot) and/or access protection. The trusted partition 52 and/or the contents of the trusted partition 52 may not be modified by a user, application, and/or an attacker unless escalation of privilege is gained. In some examples, the trusted partition 52 includes write-once memory. The trusted partition 52 includes an operating system 60 for the computer 22, a hardware security module (HSM) 62, a bootloader 64, and/or a backup application 66. The HSM 62 may include an embedded system, a computing device, and/or hardware that is configured to safeguard and/or manage digital keys, perform encryption and decryption functions for digital signatures, and/or perform authentication and/or cryptographic functions associated with securing the computer 22 and/or the trusted partition 52. In some embodiments, the bootloader 64 loads and starts boot time tasks and processes of the operating system 60 and/or the computer 22. Optionally, the backup application 66 is included with and/or runs from the HSM 62 and/or the bootloader 64.

The untrusted partition 54 includes data or code of which integrity has not been assured (e.g., unverified code/data). The untrusted partition 54 includes at least one user application 70 and/or a working space 72 associated with the user application 70. The working space 72 may include a plurality of untrusted data files 74. The working space 72 includes a location for a user and/or the user application 70 to write data files (e.g., untrusted data files 74).

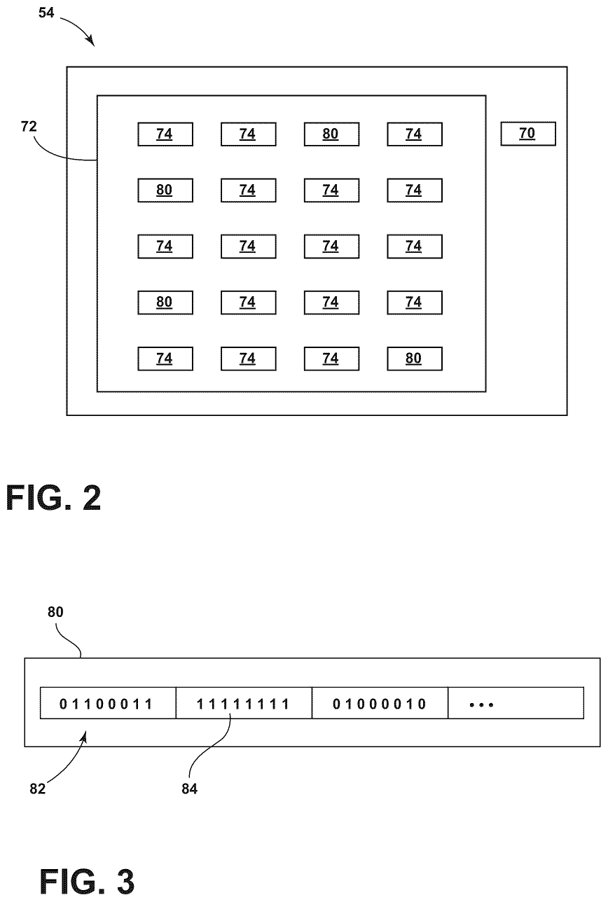

The computer 22 is configured to detect malware attacks in one or more of a variety of manners. For example and without limitation, the computer 22 may utilize one or more canary files 80 stored on the untrusted partition 54 (see, e.g., FIG. 2). A canary file 80 may include a fake data file and/or computer document disposed among the untrusted data files 74, for example, in the working space 72 of a user. Optionally, the canary files 80 are located at random locations within the untrusted partition 54 and/or at random locations among the untrusted data files 74, and the computer 22, via the processor 40 executing the backup application 66, determines whether a malware attack has occurred by detecting whether at least one of the canary files has been compromised (e.g., accessed, copied, or modified by an unauthorized user). An unauthorized user (e.g., an attacker) may compromise a canary file 80 via encryption.

FIG. 3 presents a canary file 80 in accordance with some embodiments. The canary file 80 may include a plurality of bytes 82. In some embodiments, at least one byte 84 of the plurality of bytes 84 includes a known value (e.g., predetermined bits). For example and without limitation, the byte 84 may include bits each having a value of 1. The byte 84 may be located at a random location within the canary file 80. A computer 22 and/or the backup application 66 determines whether a malware attack has occurred by determining whether the byte 84 has been modified. For instance, the computer 22 is configured to determine if any of the bits of the byte 84 have changed from a 1 to a 0.

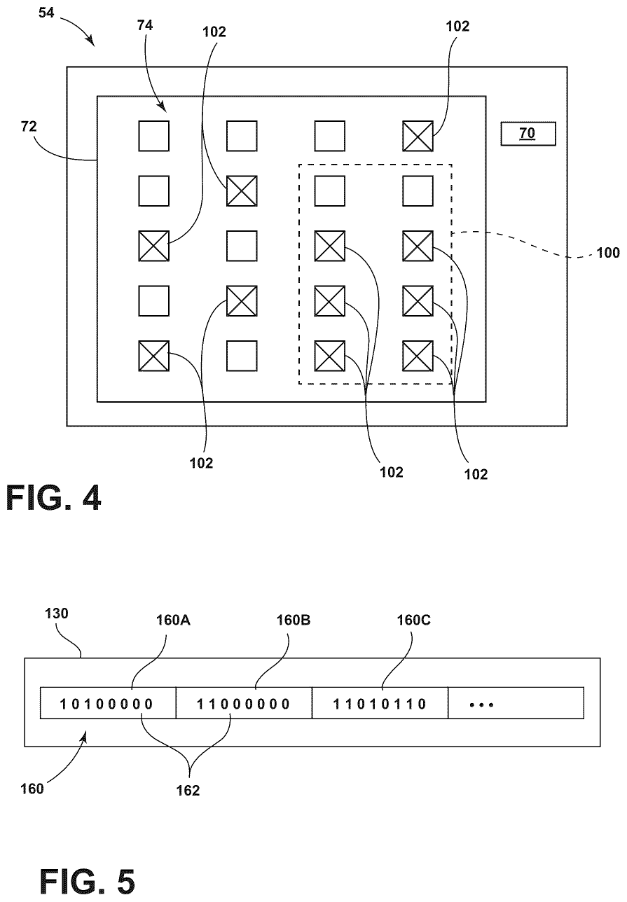

FIG. 4 presents the untrusted partition 54 in accordance with some embodiments. The untrusted partition includes a plurality of untrusted data files 74. The illustrated example of the untrusted partition 54 includes 20 untrusted data files 74, but the untrusted partition 54 may include more or less than 20 untrusted data files. In some embodiments, a computer 22 and/or the backup application 66 (e.g., the processor 40 executing the backup application 66) analyzes a sample 100 of the untrusted data files 74 to determine whether the untrusted data files 74 have been compromised (e.g., accessed, copied, or modified by an unauthorized user). For instance, the computer 22 is configured to determine if the sample 100 includes one or more compromised files 102. The sample 100 is illustrated with eight untrusted data files 74, but the sample 100 may include more or less than eight untrusted data files 74. The computer 22 is configured to determine a percentage of the sample 100 that comprises compromised files 102. The computer 22 is configured to determine that a malware attack has occurred when the percentage meets or exceeds a predetermined threshold. An authorized user may determine and/or set the size of the sample 100 size and/or the value of the predetermined threshold. For example and without limitation, the predetermined threshold may be 50%, but may be greater than or less than 50%. With the example illustrated in FIG. 4, 75% of the sample 100 are compromised files 102, so the computer 22 would detect a malware attack if the threshold is set to 50%.

The computer 22, via the backup application 66, creates a trusted backup 110 by storing at least some of the untrusted data files 74 to a backup memory 120 (see, e.g., FIG. 1). The backup memory 120 is not modifiable by the untrusted partition 54. The computer 22 is configured to automatically create a new trusted backup 110 to replace a previously created trusted backup 110 on a periodic basis. The frequency of the creation of a new trusted backup 110 may be determined and/or set via an authorized user. The computer 22 is configured to create a new trusted backup 110 unless a malware attack is detected. In accordance with detecting that the malware attack has occurred, the computer 22 and/or the backup application 66 prevents the creation of an additional trusted backup 110 and restores the untrusted data files 74 that have been compromised by the malware attack (e.g., compromised files 102) from the previously created trusted backup 110.

In some embodiments, an authorized user may determine which of the untrusted data files 74 are included in a trusted backup 110. In some examples, the trusted backup 110 includes at least one critical data file 130 of the untrusted data files 74. A critical data file 130 may include a data file that has value to a user (e.g., an authorized user) such that the user would be motivated to pay a malicious actor (e.g., an attacker, an unauthorized user, etc.) to regain access to the critical data file 130 if the critical data file 130 is compromised via a malware attack (e.g., a ransomware attack). The critical data file 130 may, for example and without limitation, include personal information, trade secret information, confidential information, and/or information used to conduct business, among others.

FIG. 5 presents an example of a critical file 130 that includes a plurality of bytes 160, such as a first byte 160A, a second byte 160B, a third byte 160C, and/or one or more additional bytes. A critical file 130 may include magic bytes 162. Magic bytes 162 include bytes (e.g., 160A and 160B) at the beginning of the critical file 130 which the computer 22 uses (e.g., via the operating system 60) to determine the file type (e.g., .jpg, zip, .png, and/or .gif, among others) of a critical file 130. In some instances, the magic bytes 162 include more than two bytes. The magic bytes 162 include known values (e.g., predetermined bits) and/or are used by the computer 22 to determine the file type independent of the file extension of a critical file 130.

In some embodiments, a trusted backup 110 may include an entire filesystem 140 of the untrusted data files 74 and/or the untrusted partition 54. Optionally, a backup memory 120 includes a portion of the trusted partition 52 of the memory 50. Additionally or alternatively, a backup memory 120′ may be disposed outside of the computer 22 and/or at a remote location in wired and/or wireless communication with the computer 22, such as via CAN, LIN, USB, IEEE 1394 (e.g., Firewire), Ethernet, radio communication, radar communication, cellular communication, Wi-Fi, and/or Bluetooth, among others.

In some embodiments, the computer 22 and/or the backup application 66 creates an interim backup 170 of untrusted data files 74, such as while the untrusted data files 74 are being scanned. The computer 22 and/or the backup application 66 may store the interim backup 170 in the trusted partition 52 and/or in an additional partition 172 of memory 50. In some instances, the computer 22 creates the interim backup 170 prior to detecting whether a malware attack has occurred. If a malware attack is not detected for the interim backup 170, the interim backup replaces the prior trusted backup 110. If a malware attack is detected, the interim backup is discarded/deleted.

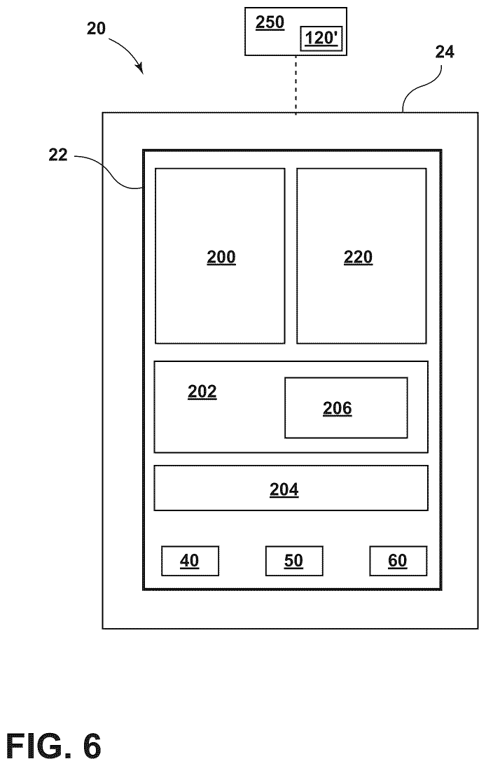

FIG. 6 presents a system 20 including a computer 22, a virtual machine 200, a hypervisor 202, and/or host hardware 204. The computer 22 includes the hypervisor 202 and/or the host hardware 204, and/or provides the virtual machine 200, such as via the hypervisor 202. Optionally, hypervisor 202 is stored on the memory 50, which may be included with and/or connected to the host hardware 204. The virtual machine 200 may provide functionality for executing an operating system 60 and/or one or more user applications.

The hypervisor 202 includes a backup application 206. The host hardware 204 includes the hardware resources (e.g., processor, memory, and/or network interface, among others) that are configured to enable one or more virtual machines to run and/or operate. Optionally, the processor 40 and the memory 50 are included with the host hardware 204. The hypervisor 202 may control what resources of the host hardware are available to the one or more virtual machines.

The computer 22 and/or the backup application 206 is configured to create a clone 220 of the virtual machine 200. The clone 220 may be an exact copy of the virtual machine 200. For instance, the clone 220 may include the same software, data files, and/or other configurations associated with the virtual machine 200. The clone 220 can run separately from and/or independent of the virtual machine 200.

The hypervisor 202 controls the operation state of a virtual machine. For instance, the hypervisor 202 changes a virtual machine from an activated state to a deactivated state and/or from a deactivated state to an activated state. The hypervisor 202 isolates the virtual machine 200 from the clone 220 such that the virtual machine 200 is unaware of and not in communication with the clone 220. The hypervisor 202 may deactivate the clone 220 while the virtual machine 200 is in an activated state and vice versa.

The computer 22 and/or the backup application 206 is configured to detect a malware attack of the virtual machine 200, such as via reading and/or scanning the virtual machine 200 and/or any data files associated with the virtual machine 200 to determine if the virtual machine 200 and/or any portion thereof has been compromised (e.g., accessed, copied, or modified by an unauthorized user). In some instances, a malware attack may involve an unauthorized user (e.g., an attacker) compromise the virtual machine 200 and/or a portion thereof via encryption.

The computer 22 and/or the backup application 206 automatically creates a new/additional clone 220 of the virtual machine 200 to replace a previously created clone 220 on a periodic basis. The frequency of the creation of a new clone 220 may be determined and/or set via an authorized user. The computer 22 and/or the backup application 206 creates a new clone 220 unless a malware attack is detected. For instance, in accordance with detecting that the malware attack has occurred, the computer 22 and/or the backup application 206 can prevent the creation of an additional clone 220 (e.g., to avoid cloning a compromised virtual machine). Additionally or alternatively, in accordance with detecting that the malware attack has occurred, the computer 22 and/or the hypervisor 202 may deactivate the virtual machine 200 and/or activate the previously created clone 220.

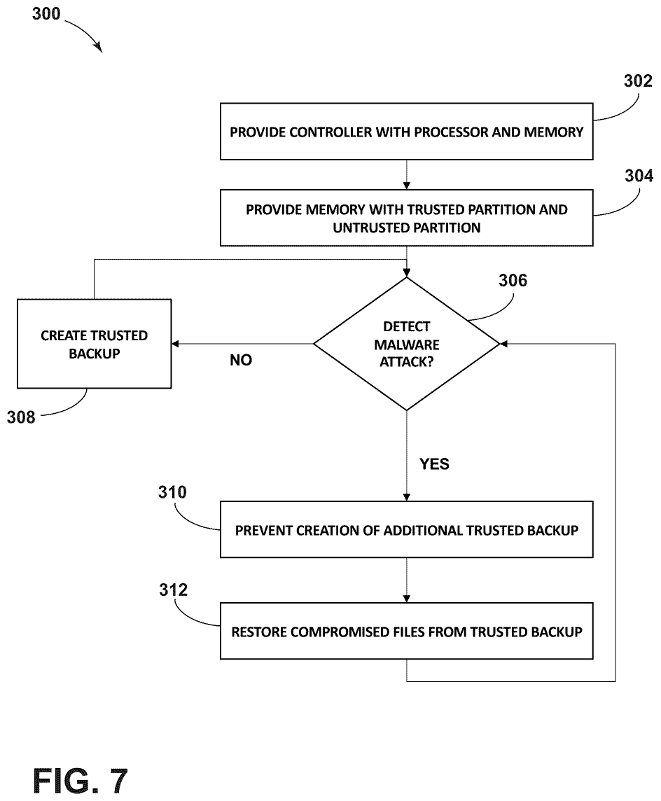

FIG. 7 presents a method 300 of operating a computer system. The method 300 includes providing a computer 22 with a processor 40 and/or memory 50 (block 302); providing the memory 50 with a trusted partition 52 and/or an untrusted partition 54 (block 304); detecting, via the computer 22, whether a malware attack of the untrusted partition 54 has occurred (block 306); creating, via the backup application 66, a trusted backup 110 by storing at least some of the untrusted data files 74 to a backup memory 120 that is not modifiable by the untrusted partition 54 in accordance with detecting that the malware attack has not occurred (block 308); preventing, via the backup application 66, the creation of an additional trusted backup 110 in accordance with detecting a malware attack (block 310); and/or restoring, via the backup application 66, compromised files 102 from the trusted backup 110 in accordance with detecting that the malware attack has occurred (block 312).

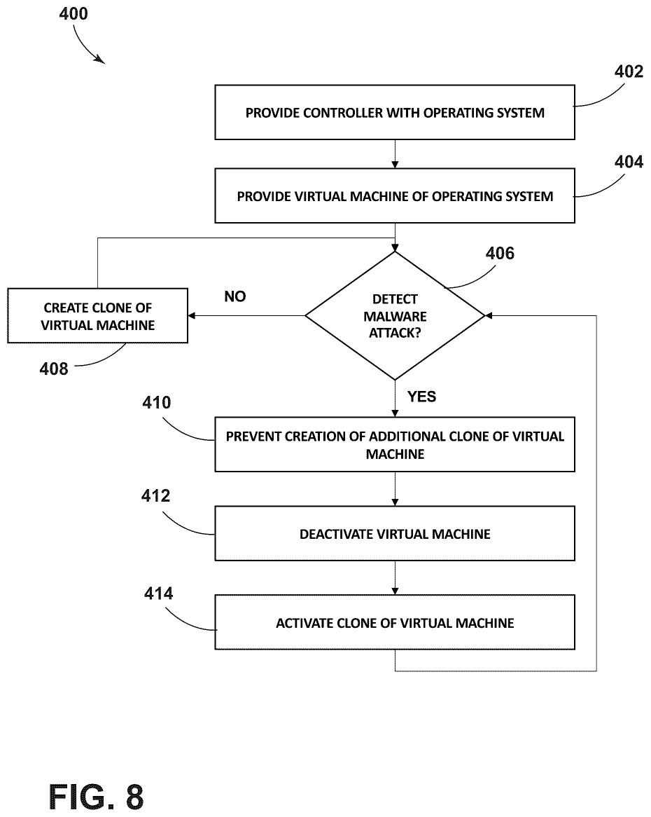

FIG. 8 presents another method 400 of operating a computer system 20. The method 400 includes providing a computer 22 with a processor 40, an operating system 60, and/or a memory 50 (block 402); providing a virtual machine 200 (block 404); detecting, via the computer 22, whether a malware attack of the virtual machine 200 has occurred (block 406); creating, via the backup application 206, a clone 220 of the virtual machine 200 in accordance with detecting that the malware attack has not occurred (block 408); preventing, via the backup application 206, the creation of an additional clone 220 of the virtual machine 200 in accordance with detecting that the malware attack has occurred (block 410); deactivating, via the hypervisor 202, the virtual machine 200 in accordance with detecting that the malware attack has occurred (block 412), and/or activating, via the hypervisor 202, the clone 220 of the virtual machine 200 in accordance with detecting that the malware attack has occurred (block 414).

Embodiments of the system 20 may be used in connection with a vehicle 24 (see, e.g., FIGS. 1 and 6). For example, the system 20 may include and/or be disposed at least partially within a vehicle 24. In some instances, the computer 22 controls one or more systems 26 of the vehicle 24. The computer 22 may, for instance, include an electronic control unit (ECU), a body control module, a chassis control module, and/or an engine/motor control module, among others. Optionally, a vehicle system 26 includes one or more of a variety of systems, such as, for example and without limitation, a driving motor, a brake system, an infotainment system, a safety device system (e.g., airbags, pretensioners, etc.), and/or a sensor system, among others. A vehicle 24 may include one or more of a variety of configurations. For example and without limitation, a vehicle 24 may include a land vehicle, a passenger car, a van, a sport utility vehicle (SUV), a crossover, a truck (e.g., a pickup truck, a commercial truck, etc.), a bus, a watercraft, an aircraft (e.g., a plane, a helicopter, etc.), and/or a combination thereof (e.g., a vehicle for land and water, a vehicle for air and water, etc.), among others. The system 20 may be configured to detect a malware attack to a computer 22 and/or a vehicle system 26, among others. With some vehicle applications, the untrusted partition 54 or a virtual machine 200 includes applications and/or data for operating one or more vehicle systems 26. For example, in accordance with detecting that the malware attack has not occurred, the untrusted partition 54 or the virtual machine 200 may operate one or more vehicle systems 26 (e.g., to control movement of the vehicle 24). In accordance with detecting that the malware attack has occurred, the computer 22 may automatically switch to a trusted backup 110 of the untrusted partition or a clone 220 of the virtual machine 200 to continue operation of the one or more vehicle systems 26. In some example configurations, a backup memory 120′ may be disposed outside of the computer 22, such as within another controller/computer disposed of a vehicle 24 and/or at a remote location (e.g., outside the vehicle 24) in communication with the computer 22 (e.g., a cloud server).

In some instances, a controller/computer 250 in communication with the computer 22 may trigger creation of a trusted backup 110 or a clone 220 of the virtual machine 200. The controller/computer 250 is disposed within a vehicle 24 (e.g., may include another ECU of a vehicle 24) and/or outside of a vehicle 24, such as at a remote location (e.g., may include a cloud server). The controller/computer 250 may be configured for detecting a malware attack and/or for recovering after the malware attack has been detected. In some example configurations, the controller/computer 250 includes a backup application 66, 206. The trusted backup 110 or clone 220 may be stored in a memory of or connected to the controller/computer 250. An integrity detection method, attestation method, and/or method to detect a violation thereof could be used as a trigger, and that the integrity/attestation check could be triggered locally or remotely.

In examples, an unauthorized user may include a person and/or a device/computer.

This disclosure includes, without limitation, the following embodiments:

1. A computer system for malware detection and recovery, comprising: a computer including a processor and a memory, the memory having: an untrusted partition including untrusted data files; and a trusted partition connected to the untrusted partition and having a backup application; wherein the trusted partition is not modifiable by the untrusted partition; the computer detects whether a malware attack on the untrusted partition has occurred; and in accordance with detecting the malware attack, the computer (i) prevents creation of an additional trusted backup and (ii) restores compromised files from the trusted backup.

2. The computer system according to embodiment 1, wherein in accordance with detecting that the malware attack has not occurred, the computer creates a trusted backup by storing at least some of the untrusted data files to a backup memory that is not modifiable by the untrusted partition; and wherein the computer creates a new trusted backup to replace a previously created trusted backup on a periodic basis unless the malware attack is detected.

3. The computer system according to any preceding embodiment, wherein the untrusted data files include data files from at least one user application; and the trusted backup includes critical data files of the untrusted data files.

4. The computer system according to any preceding embodiment, wherein the untrusted data files include data files from at least one user application; and the trusted backup includes an entire file system of the untrusted data files.

5. The computer system according to any preceding embodiment, wherein the computer creates an interim backup of the untrusted data files and stores the interim backup in the trusted partition or an additional partition of the memory before determining whether the malware attack has occurred.

6. The computer system according to any preceding embodiment, wherein: the untrusted partition includes a plurality of canary files; the canary files are located at random locations within the untrusted partition; and the computer determines whether the malware attack has occurred by detecting whether at least one of the canary files has been compromised by the malware attack.

7. The computer system according to any preceding embodiment, wherein: the untrusted partition includes at least one canary file; the canary file includes a plurality of bytes; at least one byte of the plurality of bytes includes a known value; the at least one byte is located at a random location within the canary file; and the computer determines whether the malware attack has occurred by detecting whether one or more bytes of the plurality of bytes has been modified.

8. The computer system according to any preceding embodiment, wherein the trusted partition includes an operating system of the computer.

9. The computer system according to any preceding embodiment, wherein: the computer determines a percentage of a sample of the untrusted data files that has been compromised; and the computer determines that the malware attack has occurred when the percentage exceeds a predetermined threshold.

10. The computer system according to any preceding embodiment, wherein: the untrusted data files include at least one critical file; the critical file includes a plurality of bytes; at least one byte of the plurality of bytes includes a known value; the at least one byte is located at a beginning of the critical file; and the computer determines a file type of the critical file based on the at least one byte.

11. The computer system according to any preceding embodiment, wherein the trusted partition includes write-once memory.

12. A vehicle, comprising: the computer system according to any preceding embodiment; and a plurality of vehicle systems; wherein the computer controls at least one of the plurality of vehicle systems.

13. A method of operating the computer system according to any preceding embodiment, the method comprising: detecting, via the computer, whether the malware attack of the untrusted partition has occurred; creating, via the backup application, the trusted backup by storing at least some of the untrusted data files to the backup memory that is not modifiable by the untrusted partition, in accordance with detecting that the malware attack has not occurred; preventing, via the backup application, creation of the additional trusted backup, in accordance with detecting that the malware attack has occurred; and restoring, via the backup application, compromised files from the trusted backup, in accordance with detecting that the malware attack has occurred.

14. The method according to any preceding embodiment, including creating, via the backup application, an interim backup of the untrusted data files; and storing, via the backup application, the interim backup in the trusted partition or an additional partition of the memory before determining whether the malware attack has occurred.

15. The method according to any preceding embodiment, including providing the untrusted partition with a plurality of canary files, wherein at least some of the canary files are located at random locations within the untrusted partition; and determining, via the computer, whether the malware attack has occurred by detecting whether at least one of the canary files has been compromised.

16. The method according to any preceding embodiment, including: providing the untrusted partition with at least one canary file, wherein the canary file includes a plurality of bytes; providing at least one byte of the plurality of bytes with a known value, wherein the at least one byte is located at a random location within the canary file; and determining, via the computer, whether the malware attack has occurred by detecting whether the at least one byte has been modified.

17. A computer system, comprising: a computer having a host hardware and a hypervisor, the host hardware including a processor and a memory; wherein the hypervisor provides a virtual machine and control access of the virtual machine to the host hardware; wherein the computer, via a backup application of the hypervisor: detects whether a malware attack on the virtual machine has occurred; and creates a clone of the virtual machine, in accordance with detecting that the malware attack has not occurred; the clone of the virtual machine is deactivated while the virtual machine is activated; and in accordance with detecting that the malware attack has occurred, the computer: prevents creation of an additional clone of the virtual machine, deactivates the virtual machine, and activates the clone of the virtual machine.

18. The computer system according to embodiment 17, wherein the computer creates a new clone of the virtual machine to replace a previously created clone of the virtual machine on a periodic basis unless the malware attack is detected.

19. A vehicle, comprising: the computer system according to embodiment 17 or embodiment 18; and a plurality of vehicle systems; wherein the virtual machine controls operation of at least one of the plurality of vehicle systems.

20. A method of operating the vehicle of embodiment 19, the method comprising: detecting, via the computer, whether the virtual machine has experienced the malware attack; creating, via the backup application, the clone of the virtual machine, in accordance with detecting that the malware attack has not occurred; and in accordance with detecting that the malware attack has occurred: preventing, via the backup application, creation of the additional clone of the virtual machine; deactivating, via the hypervisor, the virtual machine; and activating, via the hypervisor, the clone of the virtual machine.

In examples, a computer (e.g., computer 22) may include an electronic controller and/or include an electronic processor, such as a programmable microprocessor and/or microcontroller. In embodiments, a computer may include, for example, an application specific integrated circuit (ASIC). A computer and/or an electronic controller may include a central processing unit (CPU), a memory (e.g., a non-transitory computer-readable storage medium), and/or an input/output (I/O) interface. A computer may be configured to perform various functions, including those described in greater detail herein, with appropriate programming instructions and/or code embodied in software, hardware, and/or other medium. In embodiments, a computer may include a plurality of controllers. In embodiments, a computer may be connected to a display, such as a touchscreen display.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. The use of “e.g.” in the specification is to be construed broadly and is used to provide non-limiting examples of embodiments of the disclosure, and the disclosure is not limited to such examples. Uses of “and” and “or” are to be construed broadly (e.g., to be treated as “and/or”). For example and without limitation, uses of “and” do not necessarily require all elements or features listed, and uses of “or” are inclusive unless such a construction would be illogical.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

All matter contained in the above description or shown in the accompanying drawings shall be interpreted as illustrative only and not limiting. Changes in detail or structure may be made without departing from the present disclosure.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.”

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.”

It should be understood that a computer (e.g., computer 22) and/or a system 20 as described herein may include a conventional processing apparatus known in the art, which may be capable of executing preprogrammed instructions stored in an associated memory, all performing in accordance with the functionality described herein. To the extent that the methods described herein are embodied in software, the resulting software can be stored in an associated memory and can also constitute means for performing such methods. Such a system or processor may further be of the type having ROM, RAM, RAM and ROM, and/or a combination of non-volatile and volatile memory so that any software may be stored and yet allow storage and processing of dynamically produced data and/or signals.

It should be further understood that an article of manufacture in accordance with this disclosure may include a non-transitory computer-readable storage medium having a computer program encoded thereon for implementing logic and other functionality described herein. The computer program may include code to perform one or more of the methods disclosed herein. Such embodiments may be configured to execute via one or more processors, such as multiple processors that are integrated into a single system or are distributed over and connected together through a communications network, and the communications network may be wired and/or wireless. Code for implementing one or more of the features described in connection with one or more embodiments may, when executed by a processor, cause a plurality of transistors to change from a first state to a second state. A specific pattern of change (e.g., which transistors change state and which transistors do not), may be dictated, at least partially, by the logic and/or code.

What is claimed is:

1. A computer system for malware detection and recovery, comprising:
a computer including a processor and a memory, the memory having:
an untrusted partition including untrusted data files; and
a trusted partition connected to the untrusted partition and having a backup application;
wherein the trusted partition is not modifiable by the untrusted partition;
the computer detects whether a malware attack on the untrusted partition has occurred; and
in accordance with detecting the malware attack, the computer (i) prevents creation of an additional trusted backup and (ii) restores compromised files from the trusted backup.

2. The computer system of claim 1, wherein in accordance with detecting that the malware attack has not occurred, the computer creates a trusted backup by storing at least some of the untrusted data files to a backup memory that is not modifiable by the untrusted partition; and
wherein the computer creates a new trusted backup to replace a previously created trusted backup on a periodic basis unless the malware attack is detected.

3. The computer system of claim 1, wherein the untrusted data files include data files from at least one user application; and
the trusted backup includes critical data files of the untrusted data files.

4. The computer system of claim 1, wherein the untrusted data files include data files from at least one user application; and
the trusted backup includes an entire file system of the untrusted data files.

5. The computer system of claim 1, wherein the computer creates an interim backup of the untrusted data files and stores the interim backup in the trusted partition or an additional partition of the memory before determining whether the malware attack has occurred.

6. The computer system of claim 1, wherein:
the untrusted partition includes a plurality of canary files;
the canary files are located at random locations within the untrusted partition; and
the computer determines whether the malware attack has occurred by detecting whether at least one of the canary files has been compromised by the malware attack.

7. The computer system of claim 1, wherein:
the untrusted partition includes at least one canary file;
the canary file includes a plurality of bytes;
at least one byte of the plurality of bytes includes a known value;
the at least one byte is located at a random location within the canary file; and
the computer determines whether the malware attack has occurred by detecting whether one or more bytes of the plurality of bytes has been modified.

8. The computer system of claim 1, wherein the trusted partition includes an operating system of the computer.

9. The computer system of claim 1, wherein:
the computer determines a percentage of a sample of the untrusted data files that has been compromised; and
the computer determines that the malware attack has occurred when the percentage exceeds a predetermined threshold.

10. The computer system of claim 1, wherein:
the untrusted data files include at least one critical file;
the critical file includes a plurality of bytes;
at least one byte of the plurality of bytes includes a known value;
the at least one byte is located at a beginning of the critical file; and
the computer determines a file type of the critical file based on the at least one byte.

11. The computer system of claim 1, wherein the trusted partition includes write-once memory.

12. A vehicle, comprising:
the computer system of claim 1; and
a plurality of vehicle systems;
wherein the computer controls at least one of the plurality of vehicle systems.

13. A method of operating the computer system of claim 1, the method comprising:
detecting, via the computer, whether the malware attack of the untrusted partition has occurred;
creating, via the backup application, the trusted backup by storing at least some of the untrusted data files to the backup memory that is not modifiable by the untrusted partition, in accordance with detecting that the malware attack has not occurred;
preventing, via the backup application, creation of the additional trusted backup, in accordance with detecting that the malware attack has occurred; and
restoring, via the backup application, compromised files from the trusted backup, in accordance with detecting that the malware attack has occurred.

14. The method of claim 13, including creating, via the backup application, an interim backup of the untrusted data files; and
storing, via the backup application, the interim backup in the trusted partition or an additional partition of the memory before determining whether the malware attack has occurred.

15. The method of claim 13, including providing the untrusted partition with a plurality of canary files, wherein at least some of the canary files are located at random locations within the untrusted partition; and
determining, via the computer, whether the malware attack has occurred by detecting whether at least one of the canary files has been compromised.

16. The method of claim 13, including:
providing the untrusted partition with at least one canary file, wherein the canary file includes a plurality of bytes;
providing at least one byte of the plurality of bytes with a known value, wherein the at least one byte is located at a random location within the canary file; and
determining, via the computer, whether the malware attack has occurred by detecting whether the at least one byte has been modified.

17. A computer system, comprising:
a computer having a host hardware and a hypervisor, the host hardware including a processor and a memory;
wherein the hypervisor provides a virtual machine and control access of the virtual machine to the host hardware;
wherein the computer, via a backup application of the hypervisor:
(a) detects whether a malware attack on the virtual machine has occurred; and
(b) creates a clone of the virtual machine, in accordance with detecting that the malware attack has not occurred;
the clone of the virtual machine is deactivated while the virtual machine is activated; and in accordance with detecting that the malware attack has occurred, the computer:
(i) prevents creation of an additional clone of the virtual machine,
(ii) deactivates the virtual machine, and
(iii) activates the clone of the virtual machine.

18. The computer system of claim 17, wherein the computer creates a new clone of the virtual machine to replace a previously created clone of the virtual machine on a periodic basis unless the malware attack is detected.

19. A vehicle, comprising:
the computer system of claim 17; and
a plurality of vehicle systems;
wherein the virtual machine controls operation of at least one of the plurality of vehicle systems.

20. A method of operating the vehicle of claim 19, the method comprising:
detecting, via the computer, whether the virtual machine has experienced the malware attack;
creating, via the backup application, the clone of the virtual machine, in accordance with detecting that the malware attack has not occurred; and
in accordance with detecting that the malware attack has occurred:
preventing, via the backup application, creation of the additional clone of the virtual machine;
deactivating, via the hypervisor, the virtual machine; and
activating, via the hypervisor, the clone of the virtual machine.
